(19) United States
(12) Patent Application Publication
(10) Pub. No.: US 2026/0221663 A1
(43) Pub. Date: Jul. 30, 2026

(54) WAVEGUIDE ANTENNA, RADAR SENSOR AND VEHICLE

(71) Applicant: Continental Autonomous Mobility Germany GmbH, Ingolstadt (DE)

(72) Inventors: Johannes Kammerer, Lindau (DE); Jürgen Franz, Lindau (DE); Simon Holzner, Hettenshausen (DE); Shilpa Cicy Saji, Lindau (DE)

(73) Assignee: Continental Autonomous Mobility Germany GmbH, Ingolstadt (DE)

(21) Appl. No.: 19/143,848

(22) PCT Filed: Jan. 9, 2024
(86) PCT No.: PCT/EP2024/050386

§ 371 Date: Jun. 26, 2025

(30) Foreign Application Priority Data
Jan. 25, 2023 (IN) 202341005203
Mar. 14, 2023 (DE) 10 2023 202 299.0

(51) Int. Cl. H01Q 13/20; H01Q 1/32; H01Q 1/42

(52) U.S. Cl. CPC H01Q 13/20; H01Q 1/3233; H01Q 1/421

(57) ABSTRACT

A waveguide antenna, in particular for a radar sensor, including a radome, a waveguide, wherein the waveguide is at least partly formed by a recess in the radome, which recess at least partly has a metallization, and at least one radiating element is provided, which is arranged within the radome and extends from the waveguide, wherein the radiating element includes a non-metallized end face.

### CROSS REFERENCE TO RELATED APPLICATIONS

This application is the U.S. National Phase Application of PCT International Application No. PCT/EP2024/050386, filed Jan. 9, 2024, which claims priority to Indian Patent Application No. 202341005203 filed Jan. 25, 2023, and German Patent Application No. 10 2023 202 299.0, filed Mar. 14, 2023, the contents of such applications being incorporated by reference herein.

### FIELD OF THE INVENTION

The present invention relates to a waveguide antenna for a radar sensor, a radar sensor having a waveguide antenna according to the invention for a vehicle, as well as a vehicle which has a radar sensor according to the invention.

### BACKGROUND OF THE INVENTION

Modern means of transportation such as motor vehicles or motorcycles are increasingly being equipped with driver assistance systems which, with the aid of sensor systems, can capture the surroundings, recognize traffic situations and support the driver, e.g., by a braking or steering intervention or by outputting a visual or audible warning. Radar sensors, lidar sensors, camera sensors or the like are regularly deployed as sensor systems for capturing the surroundings. Conclusions can subsequently be drawn about the surroundings from the sensor data established by the sensors. The capturing of the surroundings by means of radar sensors is based on the emission of bundled electromagnetic waves, the reflection thereof, e.g., by other road users, obstacles on the road or the peripheral development of the road, and reception. The capturing of pedestrians is often carried out with camera sensors, but radar sensors are increasingly being deployed in this case as well.

The radar sensors are also deployed in fusion with other technology's sensors such as, e.g., camera or lidar sensors. The advantage of radar sensors, inter alia, is that they work reliably even in poor weather conditions and, in addition to the distance of objects, they can also directly measure the radial relative speed thereof via the Doppler effect. As a general rule, 24 GHz, 77 GHz and 79 GHz are deployed as transmitting frequencies. Due to the increasing functional scope of such systems, the requirements, in particular in terms of the maximum detection range, are constantly increasing. In addition to capturing the surroundings of motor vehicles for systems of the type described above, the focus is now also turning toward monitoring the interior of motor vehicles, e.g., in order to recognize which seats are occupied; frequencies in the range of 60 Hz, e.g., are deployed.

Generic radar sensors can have so-called waveguide antennas for transmitting and receiving the radar beams, in which waveguide antennas the antennas, as an individual component, consist of one or more layers. The layers can be manufactured from a plastic material which is metallized on the outside. The waveguides are closed in the combination of the antenna layers or with the circuit board which carries, e.g., the power electronics of the radar sensor. So-called radomes are subsequently used over the antenna to seal the sensors. In particular, additional losses can be incurred in the radar performance due to the radome used for sealing. In this case, a critical dimension is the distance between the radome and the antenna surface-this must be observed exactly in order to guarantee that the radome has as little influence as possible on the overall system. However, this additional component results in greater financial and production costs. There is therefore a particular need to improve the interaction between the radar antenna and the radome so that the losses in radar performance, which have a negative effect on the antenna gain, are reduced. As a general rule, the directivity and the efficiency of an antenna are combined under the antenna gain, wherein this indicates the ratio of the radiation power density of an antenna emitted or received (in the main direction) and an idealized, zero-loss reference antenna of the same antenna feed power, i.e., for example has an antenna gain of 0 dB. The antenna gain (in dB) can be indicated as a function of the angle at which the radar radiation is emitted or received.

A radar sensor for a motor vehicle having a radome, a circuit board and having at least one antenna element is known from EP 3 336 575 B1, incorporated herein by reference, wherein the antenna element comprises a dielectric resonator which is formed by a part of the radome, and has a slot antenna for feeding straight, squarely configured dielectric resonators or antenna elements. The slot antenna is configured in the circuit board. In particular, the radar sensor can also have a multiplicity of antenna elements which are arranged in a so-called array along a line, as a result of which the antenna gain is increased and the emission behavior can be bundled in the elevation direction. Furthermore, a high side lobe suppression in the elevation direction is achieved by said embodiment.

### SUMMARY OF THE INVENTION

Starting from the prior art, the problem of the present invention is now to make available a generic radar sensor with which an improvement in the radar performance can be attained in a simple and cost-effective manner.

### Solution to the Problem

The aforementioned problem is solved by the entire teaching of Claim 1 as well as the alternative, independent claims. Expedient embodiments of the invention are claimed in the subclaims.

According to an aspect of the invention, the waveguide antenna, which is in particular suitable for a radar sensor which can be deployed in the field of driver assistance systems for capturing the environment, comprises a radome, preferably made of plastic, and a waveguide. The waveguide is at least partly formed by a recess in the radome, which recess at least partly has a metallization. The metallization can be produced, for example, by physical vapor deposition (PVD), sputter deposition, thermal evaporation, chemical vapor deposition (CVD) or plasma-enhanced chemical vapor deposition (PECVD), thermal spraying, electroplating (plastic electroplating) and/or the like. Furthermore, at least one radiating element, preferably two or more radiating elements, is/are provided, which is/are arranged within the radome and extend(s) (in the emission direction) from the waveguide, wherein the radiating element comprises a non-metallized end face, so that radar beams can be transmitted and received as a result. As a result, the radome can be used as a type of lens in the region of the individual radiators, which helps to improve the radar performance. Furthermore, significantly more precise directional characteristics can be formed than with a separate radome over an antenna having multiple radiating elements. By applying metallization to the radome, tolerance problems in the distance between the antenna and the radome are overcome. Equally, the radome no longer has to observe a predefined dimension over a very large region, but rather only has to observe a predefined dimension in the region of the individual radiators or radiating elements.

The waveguide antenna can expediently be a slot antenna or a horn antenna or an OEWG (center fed open ended waveguide) antenna.

The radiating element preferably has at least one non-metallized wall region and one metallized wall region. This structural property is particularly well suited to influencing the directional characteristic of the antenna and improving the antenna gain. The desired directional characteristic can be generated by deliberately selecting non-metallized wall regions and metallized wall regions within the individual radiator or radiating element.

The radiating element can expediently have a cavity which is surrounded by non-metallized wall regions in a plane or a region in the direction of extent of the radiating element.

According to an advantageous embodiment of the waveguide antenna according to the invention, it is provided that the metallized wall regions engage or extend in(to) the radiating element at least up to one third, in particular up to half, of its height (in the direction of extent thereof).

Furthermore, the radome can have one radiating protrusion or multiple radiating protrusions which is/are arranged above the radiating element or the radiating elements in the emission direction. In this case, the radiating elements can expediently have a corresponding profile of the radiating protrusion, so that multiple radiating protrusions (i.e. one radiating protrusion for each radiating element) are provided or one radiating protrusion which in particular comprises or covers all the radiating elements.

The radiating protrusion or the radiating protrusions can expediently also have a wall or walls which is/are arranged above the radiating element or the radiating elements in the emission direction, wherein the radiating protrusion or the radiating protrusions has/have a smaller wall thickness in the region of the wall in order to specify and/or improve the directional characteristic and/or directivity of the antenna. Consequently, losses can be advantageously reduced even further by the configuration in which the individual radiators have a thinner wall on the end face.

Furthermore, the waveguide is preferably formed by a circuit board which delimits the waveguide on at least one side of the recess. A substrate, a plastic plate, a metal plate, an additional antenna layer or a circuit board having electronic components (e.g., chips, lines, power electronics, semiconductor components, IC components, transistors and/or the like) arranged thereon can be provided, for example, as the circuit board. In practical terms, the circuit board can be mounted on the underside of the radome or the radome can be attached to one side of the circuit board (by way of example, soldered, glued, screwed and/or the like), wherein the circuit board can jut out from the radome, in dimensional terms, can be smaller or, preferably, can be flush therewith. As a result, an expedient construction can be achieved in a particularly simple manner. In addition, the antenna effect of the waveguide can be improved by the special embodiment of the circuit board, so that the antenna performance can be improved even further by the special embodiment of the circuit board. Of course, the circuit board can be made of metal or likewise can have a metallization.

Furthermore, an aspect of the present invention comprises a radar sensor, in particular for recognizing objects for a vehicle, having a high-frequency component for generating and/or receiving HF signals or radar signals and a waveguide antenna according to an aspect of the invention for coupling in and/or coupling out the HF signals or for transmitting and receiving radar beams or radar signals.

In addition, an aspect of the present invention claims a motor vehicle or vehicle which has a radar sensor according to an aspect of the invention.

### BRIEF DESCRIPTION OF THE DRAWINGS

The invention is explained in greater detail below with reference to expedient exemplary embodiments, wherein:

FIG. 1 shows a simplified schematic representation of an embodiment of a waveguide antenna according to the invention (looking toward the predominantly metallized side of the waveguide antenna);

FIG. 2 shows a simplified schematic representation of a further embodiment of the waveguide antenna according to the invention (looking toward the side of the waveguide antenna which is not predominantly metallized);

FIG. 3 shows a simplified schematic representation of a further embodiment of the waveguide antenna according to the invention (looking toward the partly metallized side of the waveguide antenna);

FIG. 4 shows a simplified schematic representation of a further embodiment of the waveguide antenna according to the invention (looking toward the predominantly non-metallized side of the waveguide antenna);

FIG. 5 shows a simplified schematic representation of the waveguide antenna from FIG. 4 having a mounted circuit board (looking toward the non-metallized side of the waveguide antenna);

FIG. 6 shows a simplified schematic representation of an enlarged detail of a radiating element from FIG. 3;

FIG. 7A shows a simplified schematic exploded representation of an embodiment of the waveguide antenna according to the invention having bevels with internal radiating elements and metallization;

FIG. 7B shows a simplified schematic exploded representation of the embodiment of the waveguide antenna according to the invention from FIG. 7A with metallization depicted separately;

FIG. 8A shows a simplified schematic representation of an embodiment of a radiating element of a waveguide antenna according to the invention;

FIG. 8B shows a simplified schematic representation of a further embodiment of a radiating element of a waveguide antenna according to the invention;

FIG. 9 shows a simplified representation of an embodiment of a vehicle according to the invention;

FIG. 10 shows a simplified representation of the resulting antenna gain in elevation of a waveguide antenna according to an aspect of the invention according to FIG. 1 [frequency 76.5 GHz; θ=90°], and

FIG. 11 shows a simplified representation of the resulting antenna gain in azimuth of a waveguide antenna according to an aspect of the invention according to FIG. 1 [frequency 76.5 GHz; φ=0°].

### DETAILED DESCRIPTION OF EXEMPLARY EMBODIMENTS

A fundamental aspect of the invention is that the radome of a radar sensor, which is in actual fact flat in the prior art, is given an expedient 3D structure, wherein a part of the 3D structure or a recess in the radome forms the waveguide which is open downward or towards the non-emitting side. Said open region can then be closed with a further layer (plastic, substrate, metal or the like) or directly with a circuit board. At the other end of the waveguide in the radome, antenna structures such as individual radiators or radiating elements or slot radiators are attached in the waveguide or horn antennas, which extend from the waveguide. At least the inside of the radome is metallized, with the exception of the antenna openings, wherein the individual radiators/radiating elements radiate directly through the radome.

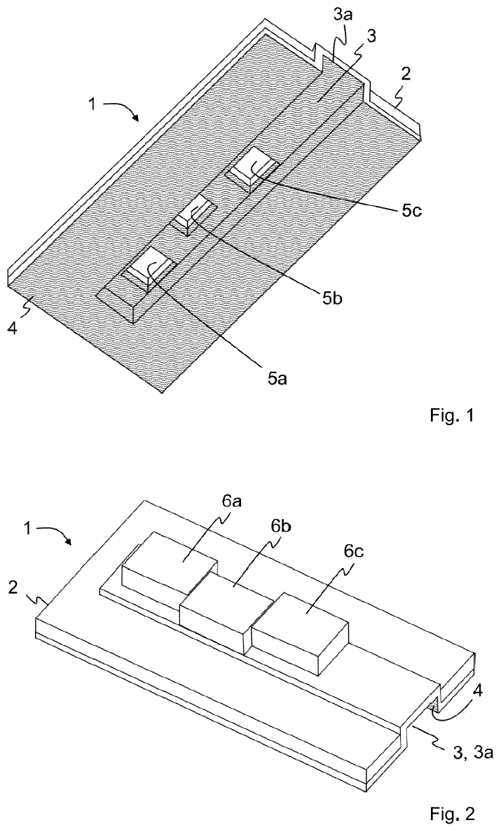

FIG. 1 shows a waveguide antenna 1 according to an aspect of the invention with a radome 2 made of plastic (looking toward the underside of the radome, i.e. the side opposite the emission direction), wherein the radome 2 has a recess which forms a waveguide 3. The waveguide 3 is fed from the opening 3a. The waveguide 3 is furthermore formed by closing it from below (i.e., the non-emitting side of the radar sensor), e.g., with a metal surface or a substrate, which can be, for example, a circuit board or a further antenna layer (not depicted in FIG. 1). Furthermore, the waveguide antenna 1 has a metallization 4 which is arranged on the entire underside of the radome 2. Moreover, three non-metallized rectangular regions are arranged, which extend from the waveguide 3 and form the slot antennas, so-called “slotted waveguides”, or three radiating elements 5a, 5b, 5c. In this case, the geometric shape of these radiating elements 5a, 5b, 5c can, however, be configured depending on the desired directional characteristic of the antenna and can, consequently, also have another configuration. According to an aspect of the invention, a part of the radome 2 is used by the internal metallization 4 of the radome 2 as part of an antenna structure, wherein the supply line thereof can be formed and used by means of a waveguide.

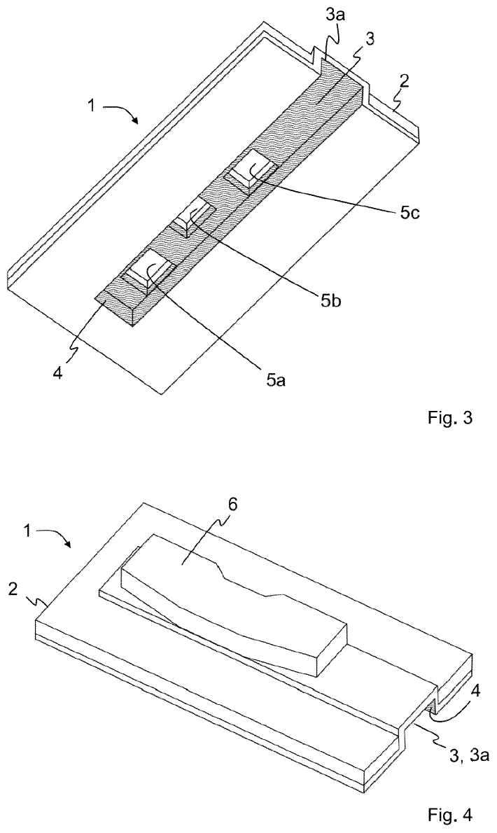

An embodiment of a waveguide antenna 1 according to an aspect of the invention looking from above onto the radome 2 is shown in FIG. 2, wherein the radome 2 has three radiating protrusions 6a, 6b, 6c, which are arranged in the region of the radiating elements 5a, 5b, 5c on the underside. Practically, the raised slot opening of the three individual radiators or radiating elements 5a, 5b, 5c has a different radome thickness or wall thickness to that provided around the waveguide 3. The directional characteristic of the waveguide antenna 1 can therefore be shaped as having a type of lens.

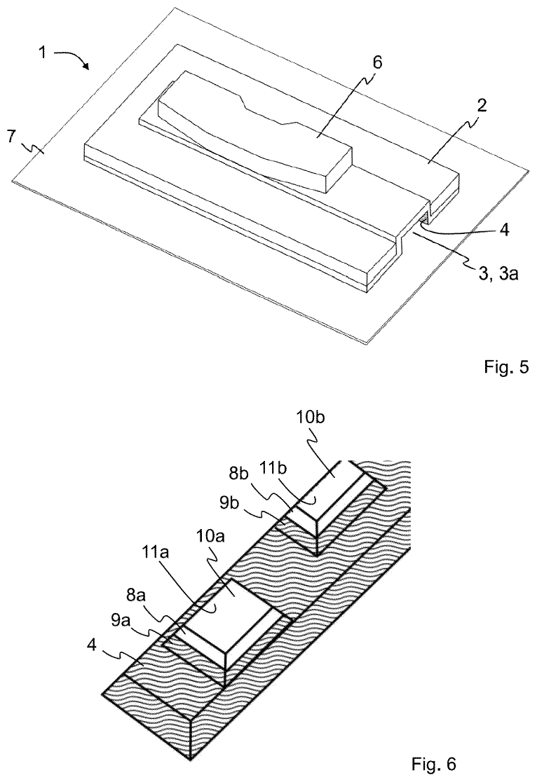

A further embodiment of a waveguide antenna 1 according to the invention (looking toward the underside) is shown in FIG. 3, wherein the underside of the radome 2 is only partly metallized or only has a metallization 4 in the region of the waveguide 3. Furthermore, an embodiment of a waveguide antenna 1 according to the invention is shown in FIG. 4, in which the radiating elements 5a, 5b, 5c are arranged under a contiguous radiating protrusion 6 of the radome 2. Said embodiment has advantages with respect to the manufacturing method of the radome 2. In the same way as the radiating protrusions 6a, 6b, 6c, the radiating protrusion 6 in the region of the radiating elements 5a, 5b, 5c can also have a thinner or smaller wall thickness than is provided around the waveguide 3 (i.e., has a smaller wall thickness) in order to specify the directional characteristic and, at the same time, improve the antenna performance. Moreover, an embodiment of a waveguide antenna 1 according to the invention is shown in FIG. 5, in which the underside of the radome 2 is closed with a circuit board 7. The circuit board 7 can be a substrate, a plastic plate, a metal plate, an additional antenna layer or a circuit board with electronic components (e.g., chips, lines, power electronics, semiconductor components, IC, transistors or the like-not depicted in FIG. 5 for the sake of clarity) arranged thereon.

An enlarged representation of the radiating elements 5a, 5b from FIG. 3 is shown in FIG. 6. In this case, the wall of the radiating elements 5a, 5b is only partly metallized and consequently has a non-metallized wall region 8a, 8b and a metallized wall region 9a, 9b. As a result, a cavity 10a, 10b or an air opening, which is surrounded by a non-metallized wall (wall region 8a, 8b), is created in the upper end of the radiating element 5a, 5b (i.e., the end of the radiating element 5a, 5b located at the end face in the emission direction). Thanks to the configuration of the radiating element 5a, 5b with such a cavity 10a, 10b on the end face in the emission direction (so to speak, above the antenna or as an antenna termination), the antenna performance can be improved to a particular extent. As a result, the tolerances in the distance between the antenna and the radome can equally be optimized or compensated for.

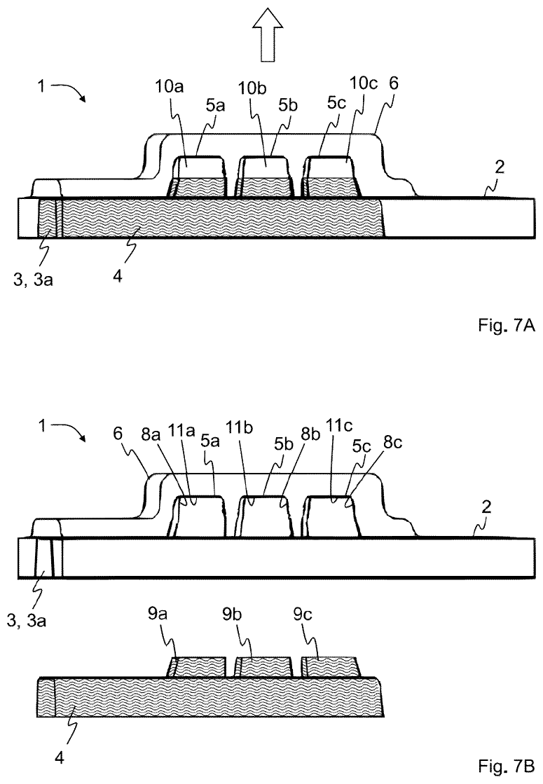

Moreover, a further embodiment of a waveguide antenna 1 according to the invention is shown in FIGS. 7A and 7B, wherein, in this case, the waveguide antenna 1 partly has bevels on the edges of the radome 2, which are substantially caused by the production (e.g., because plastic parts can be produced in the injection molding process and bevels are provided in order to remove the injection molded parts from the injection molding tool more easily). Furthermore, the emission direction of the waveguide antenna 1 is depicted in FIG. 7A as an arrow (accordingly, the radiating protrusion 6 is located on the upper side of the waveguide antenna 1). In this case, FIG. 7B shows, in a highly simplified manner, the metallization 4 detached from the rest of the radome 2 for illustration purposes, including the metallized wall regions 9a, 9b, 9c, which are preferably provided and extend or engage at least partly in(to) the radiating elements 5a, 5b, 5c of the radome 2. In an exploded representation, which is of course located within the radome 2, as depicted in FIG. 7A. In this case, it can be seen in FIGS. 7A and 7B that the metallization 4 is provided inside the radome 2 in order to form the waveguide 3. The individual radiators or radiating elements 5a, 5b, 5c are arranged inside the radiating protrusion 6 of the radome 2. These can be formed, by way of example, during the injection molding process or by subsequent processing (milling, laser, etc.) in the radome 2. In this case, the metallization 4 can be generated on the radome 2 by various coating techniques during production such as, by way of example, CVD (chemical vapor deposition) coating, electroplating, sputter deposition, thermal spraying or the like.

In this case, in practical terms, the inner walls of the radiating elements 5a, 5b, 5c can be not coated or metallized, or can only be partly coated or metallized. It is preferably provided that the inner walls of the radiating elements are only partly to be coated or metallized so that, in each case, a space or cavity 10a, 10b, 10c remains above the coating within the respective radiating element 5a, 5b, 5c, which is surrounded by uncoated walls or unmetallized wall regions 8a, 8b, 8c. Furthermore, the region of the wall of the radiating element 6 which is located above the radiating elements 5a, 5b, 5c can, contrary to the representation in FIG. 7A and FIG. 7B, also be configured to have very much thinner walls than the rest of the wall of the radiating protrusion 6. The partial metallization of the inner walls of the radiating elements 5a, 5b, 5c can be carried out, for example, by only partly metallizing the wall regions during the metallization step or by initially metallizing the interior of the radome 2, preferably completely, and subsequently removing the metallization within the radiating elements 5a, 5b, 5c again (by way of example, by milling or laser or the like). In the course of this processing, the last segment or the cavity 10a, 10b, 10c can also be generated (wholly or partly) by means of a laser or milling machine, so that the uppermost region of the respective radiating element 5a, 5b, 5c is also produced with a non-metallized wall region 8a, 8b, 8c.

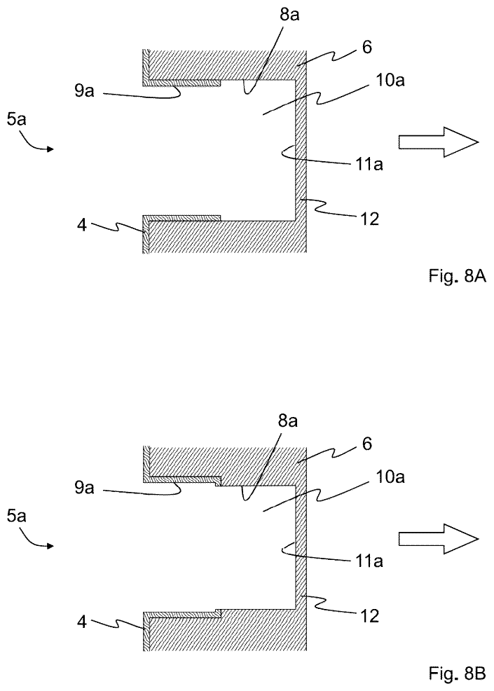

FIG. 8A shows a simplified representation of an embodiment of the radiating element 5a of a waveguide antenna according to the invention, wherein the emission direction of the waveguide antenna is depicted by the arrow (accordingly, in the emission direction, the side on which the end face 11a is located is referred to as the emission side or upper side-furthermore, the radiating element extends from the waveguide 3 in the emission direction). In this case, the radiating element 5a has an inner wall and is hollow. The inner wall is in particular characterized in that said inner wall has a non-metallized wall region 8a and a metallized wall region 9a. In this case, the non-metallized wall region 8a surrounds the cavity 10a in a plane or a region in the emission direction or the direction of extent of the radiating element 5a (starting from the waveguide 3). Furthermore, the end face 11a of the individual radiator or radiating element 5a is also not metallized, so that the radar radiation can radiate directly through the wall or the end face 11a. In this case, radar beams can of course be transmitted in the emission direction and received from the emission direction, depending on whether signals are to be transmitted or received. In order to attain the desired directional characteristic of the antenna and to improve the radar transmission or radar reception (i.e., in particular to improve the antenna performance as well as the antenna gain), the wall 12 of the radiating protrusion 6 above the radiating element 5a can be configured to be much thinner-walled than the remaining wall of the radiating protrusion 6, as depicted in FIG. 8A. Furthermore, FIG. 8B shows a further embodiment of the radiating element 5a of a waveguide antenna according to the invention, wherein the cavity 10a surrounded by the non-metallized wall 8a has a smaller (or possibly also the same) size than the region surrounded by the metallized wall 9a. For example, this can be done by milling. Thanks to this configuration, it is ensured that the metallization is not damaged when the cavity 10a is subsequently milled, or when metallization which has reached the wall 8a during production (e.g., when the interior of the radome 2 is initially completely metallized during manufacture) is removed from the wall 8a.

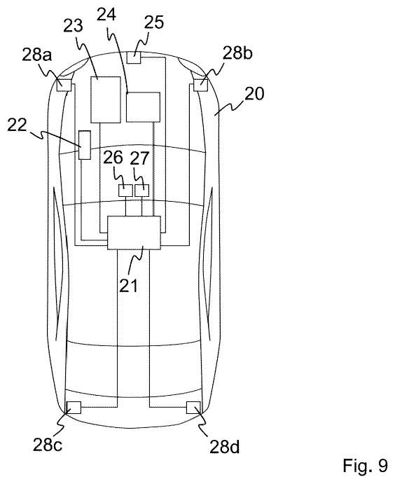

A vehicle 20 according to an aspect of the invention having a control device 21 (ECU, Electronic Control Unit or ADCU, Assisted and Automated Driving Control Unit) is shown in FIG. 9. A sensor control, sensor data fusion, environment and/or object recognition, trajectory planning and/or vehicle control can take place, in particular (partly) autonomously by the control device 21. To control the vehicle, the control device 21 can have recourse to various actuators (steering 22, engine 23, brake 24). Furthermore, the vehicle 20 has a radar sensor 25 according to an aspect of the invention, a lidar sensor 26, a camera 27 as well as ultrasonic sensors 28a-28d for capturing the environment. The sensor data can be advantageously utilized for recognizing the environment and objects so that various assistance functions such as, e.g., Emergency Brake Assist (EBA), Adaptive Cruise Control (ACC), a Lane Departure Warning System or a Lane Keep Assist (LKA) or the like can be realized. Furthermore, the assistance functions can likewise be executed via the control device 21 or another control unit provided for this purpose.

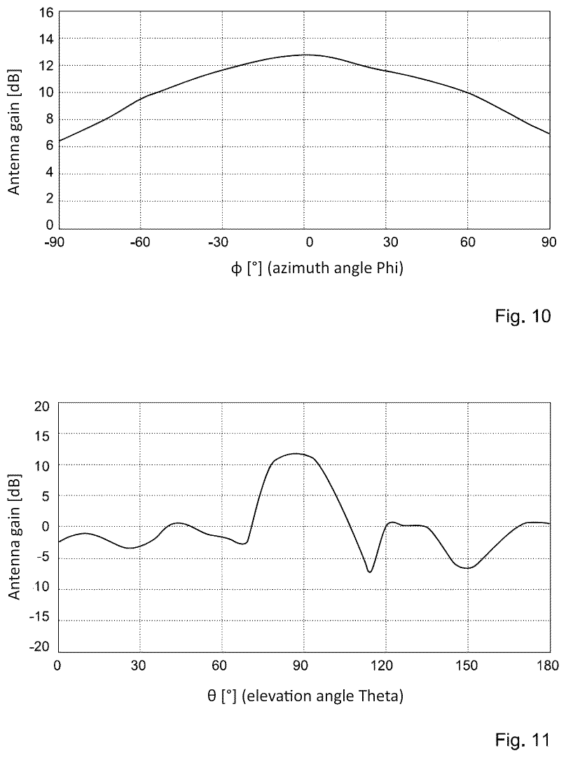

The resulting antenna gain in elevation and azimuth of the waveguide antenna 1 from FIG. 1 and FIG. 2 is depicted in FIG. 10 and FIG. 11.

In summary, the advantages of the invention are that by applying a metallization in the radome, tolerance problems in the distance between the antenna and the radome can be overcome. Equally, the radome no longer has to observe a predefined dimension over a very large area, but rather only has to observe a predefined dimension in the region of the individual radiators or radiating elements. The radome in the region of the individual radiators can equally be used as a type of lens. Significantly more precise directional characteristics can therefore be formed than with a separate radome over an antenna having multiple radiating elements. The radome can also advantageously be made thinner at the location of the individual radiators, as a result of which losses can be reduced even further. In addition, the invention can be advantageously used for all radar sensors, in the field of car-2-X or car-2-car communication for higher frequencies and in all radio systems in which waveguide antennas are deployed.

### LIST OF REFERENCE NUMERALS

1 Waveguide antenna
2 Radome
3 Waveguide
3a Opening
4 Metallization
5a, 5b, 5c Radiating element
6 Radiating protrusion
6a, 6b, 6c Radiating protrusion
7 Circuit board
8a, 8b, 8c Non-metallized wall region
9a, 9b, 9c Metallized wall region
10a, 10b, 10c Cavity
11a, 11b, 11c End face
12 Wall
20 Vehicle
21 Control device
22 Steering
23 Engine
24 Brake
25 Radar sensor
26 Lidar sensor
27 Camera
28a, 28b, 28c, 28d Ultrasonic sensor

1. A waveguide antenna for a radar sensor, comprising:
a radome, and
a waveguide, wherein
the waveguide is at least partly formed by a recess in the radome, which recess at least partly has a metallization, and
at least one radiating element is provided, which is arranged within the radome and extends from the waveguide, wherein the radiating element comprises a non-metallized end face.

2. The waveguide antenna according to claim 1, wherein the waveguide antenna is a slot antenna or a horn antenna or an OEWG antenna.

3. The waveguide antenna according to claim 1, wherein the radiating element has at least one non-metallized wall region and a metallized wall region.

4. The waveguide antenna according to claim 3, wherein the radiating element has a cavity which is surrounded in a plane by non-metallized wall regions.

5. The waveguide antenna according to claim 1, wherein the metallized wall regions extend into the radiating element at least up to one third, in particular up to half, of its height.

6. The waveguide antenna according to claim 1, wherein the radome has a radiating protrusion or multiple radiating protrusions which is/are arranged above the radiating element or the radiating elements in the emission direction.

7. The waveguide antenna according to claim 6, wherein the radiating protrusion or the radiating protrusions has/have a wall/walls which is/are arranged above the radiating element or radiating elements in the emission direction, wherein the radiating protrusion or the radiating protrusions has/have a smaller wall thickness in the region of the wall.

8. The waveguide antenna according to claim 1, wherein the waveguide is further formed by a circuit board which delimits the waveguide on at least one side of the recess.

9. A radar sensor, in particular for recognizing objects for a vehicle, having a waveguide antenna according to claim 1.

10. A vehicle having a radar sensor according to claim 9.
